(19) United States
(12) Patent Application Publication
(10) Pub. No.: US 2024/0036307 A1
(43) Pub. Date: Feb. 1, 2024

(54) OPTICAL DISPLAY SYSTEM WITH EXIT PUPIL STEERING

(71) Applicants: UNUVERSITY OF CENTRAL FLORIDA RESEARCH FOUNDATION, INC., ORLANDO, FL (US); GOERTEK INC., WEIFANG, SHANDONG (CN)

(72) Inventors: JIANGHAO XIONG, Orlando, FL (US); Yannangqi Li, Orlando, FL (US); Kun Li, Santa Clara, CA (US); Shin-Tsson Wu, Oviedo, FL (US)

(73) Assignees: UNUVERSITY OF CENTRAL FLORIDA RESEARCH FOUNDATION, INC., ORLANDO, FL (US); GOERTEK INC., WEIFANG, SHANDONG (CN)

(21) Appl. No.: 18/276,143

(22) PCT Filed: Feb. 8, 2022
(86) PCT No.: PCT/CN2022/075506

§ 371 Date: Aug. 7, 2023

Related U.S. Application Data
(60) Provisional application No. 63/146,781, filed on Feb. 8, 2021.

(51) Int. Cl. G02B 27/00; G02B 27/01; G02B 27/42

(52) U.S. Cl. CPC G02B 27/0081; G02B 27/0172; G02B 27/0093; G02B 27/4261; G02B 2027/0178

(57) ABSTRACT

An exit pupil steering device (110) comprises: at least one first lens coupler module, each of which includes: a first controllable polarization converter (114), which can convert an incident light (140) of a first polarization state into a second polarization state under control, and a first diffractive lens (113), which diffracts the incident light of the first polarization state to a first pupil location of a viewer (142) and passes the incident light of the second polarization state, or which passes the incident light of the first polarization state and diffracts the incident light of the second polarization state to the first pupil location (142); and a second lens coupler module, which is placed after the first lens coupler module and diffracts the incident light to a second pupil location of the viewer (144). The exit pupil steering device (110) can be used in an optical display system and an electronics apparatus (70).

### CROSS-REFERENCE TO RELATED APPLICATIONS

This application is a National Stage of International Application No. PCT/CN2022/075506, filed on Feb. 8, 2022, which claims priority to U.S. Application No. 63/146,781, filed Feb. 8, 2021, both of which are hereby incorporated by reference in their entireties.

### FIELD OF THE INVENTION

This disclosure relates to the technical field of optical display system, and more specifically, to an exit pupil steering device, an optical display system and an electronics apparatus.

### BACKGROUND OF THE INVENTION

An head-mounted display (HMD) projects virtual images to a viewer's eye. Field of view of an HMD determines the size of virtual image perceived by the viewer. Eye box size measures the movable range of viewer's eye, out of which no image light enters use's eye.

In conventional HMDs, there is generally a trade-off between field of view and exit pupil size due to the conservation of optical etendue. To increase optical etendue often means to enlarge size of optical modules, which compromises wearing comfort. To steer the location of exit pupil can significantly improve the movable range of viewer's eye and can avoid the issue of optical etendue conservation. Conventional pupil steering methods are generally based on changing incident light angle on optical elements like a diffraction lens. These methods can induce serious aberrations because the wave front of optical element is usually fixed and work well only for one incident angle.

### SUMMARY OF THE INVENTION

One object of this disclosure is to provide a new technical solution for exit pupil steering.

According to a first aspect of the present disclosure, there is provided an exit pupil steering device, comprising: at least one first lens coupler module, each of which includes: a first controllable polarization converter, which can convert an incident light of a first polarization state into a second polarization state under control, and a first diffractive lens, which diffracts the incident light of the first polarization state to a first pupil location of a viewer and passes the incident light of the second polarization state, or which passes the incident light of the first polarization state and diffracts the incident light of the second polarization state to the first pupil location; and a second lens coupler module, which is placed after the first lens coupler module and diffracts the incident light to a second pupil location of the viewer.

According to a second aspect of the present disclosure, there is provided an optical display system, comprising: an optical image-generating display apparatus, which generates display light; and the exit pupil steering device according to an embodiment, which receives the display light as the incident light and diffracts the incident light so that an exit pupil of the optical display system is steered to match a pupil location of a viewer.

According to a third aspect of the present disclosure, there is provided an electronics apparatus, including the optical display system according to an embodiment.

According to an embodiment of this disclosure, an optical display system can provide a relatively large movable range without significantly compromising the optical performance.

Further features of the present disclosure and advantages thereof will become apparent from the following detailed description of exemplary embodiments according to the present disclosure with reference to the attached drawings.

### BRIEF DESCRIPTION OF THE DRAWINGS

The accompanying drawings, which are incorporated in and constitute a part of the specification, illustrate embodiments of the invention and, together with the description thereof, serve to explain the principles of the invention.

FIGS. 1A and 1B illustrate the working principle an optical display system according to an exemplary embodiment of the invention.

FIG. 2 is schematic plan view of a controllable optical image-generating display apparatus according to an exemplary embodiment of the invention.

FIG. 3A is a sketch for a lens coupler module according to an exemplary embodiment of the invention.

FIG. 3B is a sketch for local molecular configuration of a diffractive liquid crystal lens.

FIGS. 3C and 3D illustrate the working principle of o a controllable polarization converter according to an exemplary embodiment of the invention.

FIG. 4A shows measured Stokes parameter S3 of output light when a voltage is applied.

FIG. 4B shows response time curves at applied voltage of 2V.

FIG. 5A shows lenses with opposite responses to a circularly polarized light.

FIG. 5B shows an experiment arrangement according to an embodiment.

FIG. 6A shows an experiment result according to an embodiment.

FIG. 6B shows another experiment result according to an embodiment.

FIG. 7 shows an electronics apparatus according to an embodiment.

### DETAILED DESCRIPTION OF THE EMBODIMENTS

Various exemplary embodiments of the disclosure will now be described in detail with reference to the drawings. It should be noted that the relative arrangement of the components and steps, the numerical expressions, and numerical values set forth in these embodiments do not limit the scope of the disclosure unless it is specifically stated otherwise.

The following description of at least one exemplary embodiment is merely illustrative in nature and is in no way intended to limit the invention, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed for following figures.

In various embodiments, an exit pupil steering device may comprises: at least one first lens coupler module and a second lens coupler module. Each of the first lens coupler module includes: a first controllable polarization converter and a first diffractive lens. The first controllable polarization converter can convert an incident light of a first polarization state into a second polarization state under control. The first diffractive lens diffracts the incident light of the first polarization state to a first pupil location of a viewer and passes the incident light of the second polarization state, or which passes the incident light of the first polarization state and diffracts the incident light of the second polarization state to the first pupil location. The second lens coupler module is placed after the first lens coupler module and diffracts the incident light to a second pupil location of the viewer. The first pupil location and the first pupil location are different. That is, the first diffractive lens diffracts the incident light at a first exit pupil, and the second lens coupler module diffracts the incident light at a second exit pupil different from the first exit pupil.

Here, with the exit pupil steering device, an optical display system can provide a relatively large movable range without significantly compromising the optical performance.

For example, the first diffractive lens is a diffractive liquid crystal lens. The incident light may be circularly polarized. The first polarization state and the second polarization state are of opposite handedness. In an example, the first polarization state is right handedness polarization state and the second polarization state is left handedness polarization state. Alternatively, the first polarization state is left handedness polarization state and the second polarization state is right handedness polarization state.

In an example, the first controllable polarization converter is controlled to convert the incident light of the first polarization state into a second polarization state, and the first diffractive lens passes the incident light of the second polarization state.

In another example, the first controllable polarization converter is controlled to convert the incident light of the first polarization state into a second polarization state, and the first diffractive lens diffracts the incident light of the second polarization state.

In a still another example, the first controllable polarization converter is controlled to pass the incident light of the first polarization state, and the first diffractive lens passes the incident light of the first polarization state.

In a further another example, the first controllable polarization converter is controlled to pass the incident light of the first polarization state, and the first diffractive lens diffracts the incident light of the first polarization state.

For example, the at least one first lens coupler module includes two first lens coupler modules, and the first diffractive lenses of the two first lens coupler modules diffract the incident lights of different polarization states. Furthermore, the first diffractive lenses of the at least two lens coupler modules may diffract the incident light to different first pupil locations or at different first exit pupils.

In an embodiment, the second lens coupler module may include: a second controllable polarization converter and a second diffractive lens. The second controllable polarization converter converts the incident light of the first polarization state into the second polarization state. The second diffractive lens diffracts the incident light of the second polarization state.

For example, the second diffractive lens diffracts the incident light which has a polarization state opposite to that of that of the first diffractive lens of the last first lens coupler module.

The first diffractive lens of the last first lens coupler module may pass the incident light of the first polarization state or the second polarization state, and the second diffractive lens can diffract the incident light of the first polarization state or the second polarization state.

In another embodiment, the second lens coupler module may include: a second controllable polarization converter and a second diffractive lens. The second controllable polarization converter converts the incident light of the second polarization state into the first polarization state. The second diffractive lens diffracts the incident light of the first polarization state. The second diffractive lens may be a diffractive liquid crystal lens.

In an embodiment, the second lens coupler module includes a second diffractive lens diffracts the incident light from a last first lens coupler module before the second lens coupler module.

For example, the second diffractive lens diffracts the incident light which has a polarization state opposite to that of that of the first diffractive lens of the last first lens coupler module. In this situation, the first diffractive lens of the last first lens coupler module passes the incident light of the first polarization state or the second polarization state, and the second diffractive lens diffracts the incident light of the first polarization state or the second polarization state.

The first and/or second diffractive lens, which may be diffractive liquid crystal lens, may focus the incident light into a first reflective order. The diffractive lens may be fabricated with a patterned bottom photo-alignment layer and cholesteric liquid crystal placed on the photo-alignment layer. The diffractive lens is fabricated by polarization volume holography to directly record volume birefringence by exposure of two interfering beams.

For example, the polarization converter may be made of a homogeneous LC cell. The cell gap of the homogeneous LC cell may be 2 micrometers. The LC cell may have birefringence of 0.284.

In various embodiments, an optical display system may comprises: an optical image-generating display apparatus, which generates display light; and the exit pupil steering device as described above. The exit pupil steering device receives the display light as the incident light and diffracts the incident light so that an exit pupil of the optical display system is steered to match a pupil location of a viewer.

For example, the optical image-generating display apparatus is programmable/controllable, and may be configured to output circularly polarized light, such as right handedness light or left handedness light. The optical image-generating display apparatus may include a programmable image-generating component and an imaging optical component. The imaging optical component may include a bi-convex lens. For example, the image-generating component is at least one of an organic light emitting diode (OLED) display, a liquid crystal on silicon (LCOS) display, a laser-scanning display with micro-electromechanical system (MEMS), and a micro light emitting diode (μLED) display. In an example, a circular polarizer is incorporated between the image-generating component and the imaging optical component to produce circularly polarized light output. The imaging optical component may include a plurality of lenses, which are refractive-type or diffractive-type, and have a plurality of reflective surfaces.

In an embodiment, the optical display system may further comprises a controlling unit, which controls the first controllable polarization converter of the first lens coupler module.

In another embodiment, the optical display system may further comprises an eye tracking apparatus. The eye tracking apparatus detects the location of a viewer's eye pupil and provides the location to the controlling unit. The controlling unit can control the first controllable polarization converter according to the location.

For example, the controlling unit steers light from the optical image-generating display apparatus to viewer's eye pupil by turning on the lens coupler module with closer distance to viewer's eye pupil, according to the location of the eye pupil determined by the eye tracing apparatus. The plurality of lens coupler modules can be independently controlled whether to diffract or transmit light. According to the eye pupil location determined by the eye tracking system, the controlling unit can turn on the lens coupler module with the closest focus point to the eye pupil, so that light can be steered to viewer's eye.

In another example, the lens coupler module can be turned on or off, or the first diffractive lens may be activated, by the controllable polarization converter. For example, the first controllable polarization converter has two possible states that can be selected by programming. In state one, the first controllable polarization converter reverts the handedness of incident circularly polarized light. In state two, the first controllable polarization converter preserves the polarization state of incident circularly polarized light.

In this disclosure, various embodiments relate to exit pupil steering device, which can be used in an optical display system. The optical display system can be an augmented reality system that includes a controllable optical image-generating apparatus and an optical image-viewing apparatus. Various embodiments may also relate to associated methods and applications. In various embodiments, exit pupil of optical display system can be steered to match the location of a viewer's pupil. Various embodiments can be used in wearable display devices including virtual and/or augmented reality devices.

For example, the electronics apparatus may be an HMD. The HMD includes an optical display system, which includes an exit pupil steering device. The exit pupil steering device is used for exit pupil steering for the HMD. The HMD can have a wide field of view and a large exit pupil size.

In an exemplary, non-limiting embodiment, the optical display system can include a controllable optical image-generating display apparatus, an exit pupil steering apparatus, an eye tracking apparatus and a controlling unit. In a non-limiting exemplary embodiment, the optical image-generating apparatus has an optical axis and includes a programmable/controllable image-generating component; an imaging optical component. For example, the imaging optical component is disposed to magnify and collimate the image-generating component. The programmable/controllable image-generating component may be configured to output circularly polarized light, i.e. it is adapted to generate a polarized image output.

The exit pupil steering apparatus may include a plurality of lens coupler modules. Each lens coupler module includes a controllable polarization converter and a diffractive liquid crystal lens. The controllable polarization converter can change the polarization state of light with a certain oblique incident angle under an applied controlling voltage from the controlling unit. The polarization state is changed between circular polarization with opposite handedness. The diffractive liquid crystal lens focuses the light with one circular polarization state to a point and let light with the other polarization state pass directly through. The eye tracking apparatus detects the location of viewer's eye pupil and provides this information to the controlling unit.

In some embodiments, the exit pupil steering apparatus includes a plurality of lens coupler modules. Each lens coupler module has a distinct focus point. By controlling the polarization converter in each lens coupler module, the lens function can be switched between on and off state. The input light can be selectively diffracted by a specific lens coupler module. With the pupil position information provided by the eye tracking apparatus, the controlling unit can decide which lens coupler module to function. The wave front of each diffractive liquid crystal is recorded separately and can be designed to minimize optical aberrations.

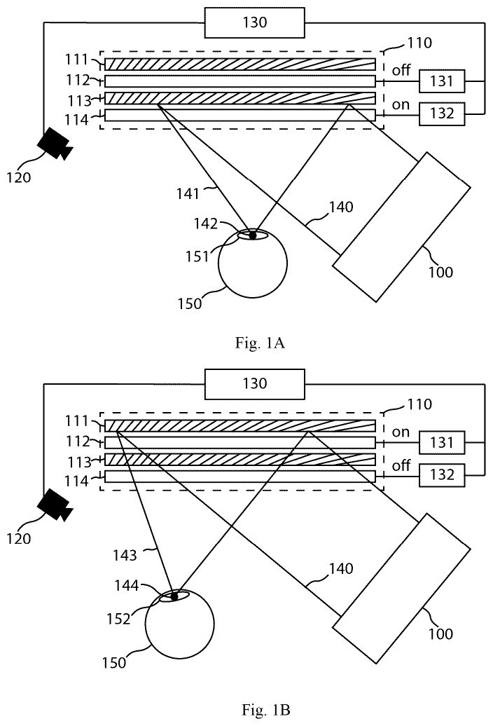

FIGS. 1A and 1B schematically illustrates an optical display system with exit pupil steering. The display system comprises a controllable optical image-generating display apparatus 100, an exit pupil steering apparatus 110, an eye tracking apparatus 120 and a controlling unit 130. The exit pupil steering apparatus includes two controllable polarization converter 112 and 114, which are individually controlled by electronic switches 131 and 132. The polarization converter has the function to convert incident circularly polarized light between circular polarization states two opposite handedness. The function can be turned on or off by the electronic switch. The exit pupil steering apparatus also includes two diffractive liquid crystal lenses 111 and 113, which functions under circularly polarized light with a certain handedness. The number of controllable polarization converter and diffractive liquid crystal is for purpose of description and should not be limiting. The controllable optical image-generating display apparatus 100 emits circularly polarized light 140 with a handedness that is opposite to that of liquid crystal lens 113. The handedness of light 140 is converted to the opposite handedness after passing controllable polarization converter 114. The light is diffracted by diffractive liquid crystal lens 113 and becomes light 141. Light 141 is imaged to position 142, which is within pupil position 151 of viewer's eye 150.

The eye tracing apparatus 120 tracks the position of eye pupil and deliver the information to controlling unit 130. When the viewer's eye 150 is moved and the eye pupil position is changed to 152 in FIG. 1B. The controlling unit turns off electronic switch 132 and turns on electronic switch 131. Light 140 does not change the polarization state after passing polarization converter 114. The diffractive liquid crystal lens 113 does not respond to light 140. Light 140 then encounters polarization converter 112 and is converted to circular polarization state with opposite handedness. The light is diffracted by diffractive liquid crystal lens 111 and becomes light 143. Light 143 is imaged to position 144, which is within pupil position 152 of viewer's eye 150.

The relation of handedness among display light 140, diffractive liquid crystal lenses 111 and 113 are only for purpose of description and should not be a limitation. For example, in some embodiments, light 140 may have the same handedness as that can be processed by the diffractive liquid crystal lens 113. In this situation, the electronic switch 132 shall be turned off in order for light 140 to be diffracted by the liquid crystal lens 113. In some embodiments, the light handedness for liquid crystal lens 111 may be different from that for the liquid crystal lens 113. When display light 140 passes liquid crystal lens 113, the electronic switch 131 should be turned off in order for display light 140 to be diffracted by liquid crystal lens 113. In this situation, the electronic switch 131 may be omitted.

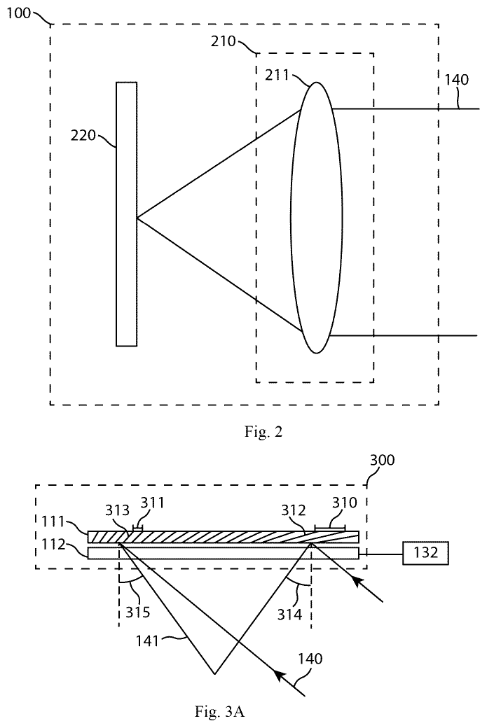

As shown in FIG. 2, the controllable optical image-generating display apparatus 100 includes a programmable image-generating component 220 and an imaging optical component 210 with a bi-convex lens 211. In some embodiments, the image-generating component 220 may be an organic light emitting diode (OLED) display, a liquid crystal on silicon (LCOS) display, a laser-scanning display with micro-electromechanical system (MEMS), a micro light emitting diode (μLED) display or other display components known in the art. If the display light is not inherently polarized, as produced by, for example, a micro-LED display or an OLED display, then a circular polarizer may be incorporated to produce circularly polarized light output. The imaging optical component 210 may, in some embodiments, include a plurality of lenses, which can be refractive-type or diffractive-type, and/or a plurality of reflective surfaces.

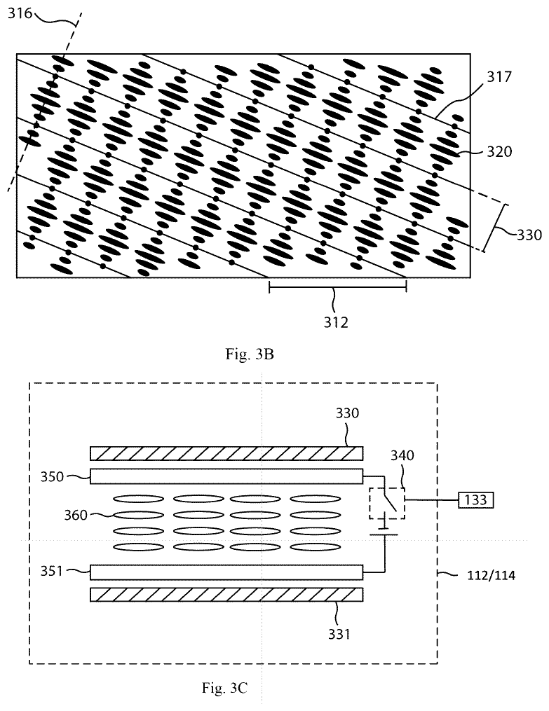

FIG. 3A shows one lens coupler modules 300. The exit pupil steering device may include a plurality of lens coupler modules 300. The lens coupler module 300 includes a controllable polarization converter 112 and a diffractive liquid crystal lens 111. Diffractive liquid crystal lens 111 may have a spatially variant Bragg surface, which varies from Bragg surface 312 to 313. For incident light 140, diffraction angle of each local lens region is determined by the lens pattern period in plane. Diffraction angle 314 is determined by local pattern period 310. Diffraction angle 315 is determined by local pattern period 311.

FIG. 3B illustrates the inner liquid crystal molecular structure of a local region of diffractive liquid crystal lens 111. Liquid crystal molecules 320 spatially rotate along helical axis 316. Bragg surface 317 is perpendicular to helical axis 316. The pitch of helical structure 330 and position of helical axis 316 can be used to derive in-plane pattern period 312. In some embodiments, the structure of liquid crystal lens 111 can be achieved with photo-alignment technology and cholesteric liquid crystal. The photo-alignment layer is used to record the bottom pattern. The cholesteric liquid crystal, which naturally forms helical structures, is placed on the photo-alignment pattern to form the structure in FIG. 3B. In some embodiments, the structure in FIG. 3B can be directly recorded with volume polarization holography, where a liquid crystal polymer layer is exposed under interfering light to record the pattern in volume.

The controllable polarization converter has the function of switching the handedness of incident circularly polarized light, which can be controlled with an electronic switch. In some embodiments, it includes a homogeneous liquid crystal cell with two compensation films, as shown in FIGS. 3C and 3D. Liquid crystal 360 is between two substrates 350 and 351 with electrodes. An electronic switch 133 controls the open and closed states of controller 340. When controller 340 is open, as shown in FIG. 3C, no voltage is added to liquid crystal. Polarization converter 112/114 is at on state. The liquid crystal is lying parallel to substrates 350 and 351. Polarization converter 112/114 has the function of switching the handedness of incident circularly polarized light. Compensation films 330 and 331 are used to improve the angular performance of polarization converter 112/114. Each compensation film may include a plurality of A-films, C-films and biaxial films. The birefringent properties of each A-film, C-film and biaxial film, like birefringence and axial position of A-film, can be arbitrary so that the final combination of those films can produce a good angular performance in on-state of polarization converter 112/114. A good angular performance in on-state refers to that output circular polarized light should have a Stokes parameter S3 with absolute value close to 1, while the sign of S3 for output light is opposite to that of incident light, for light with a large range of incident angle. When controller 340 is closed, as shown in FIG. 3D, polarization converter 112/114 is at off state. A voltage is added onto liquid crystal molecules 360 and make them rotate to angle 361. At this state, the circular polarization state of incident light is not changed after passing polarization converter 112/114. Angle 361 may be changed according to designs of different embodiments. Angle 361 and compensation films 330 and 331 should be designed to have a good angular performance in off state. A good angular performance in off-state refers to that output circular polarized light should have a stokes parameter S3 with absolute value close to 1, while the sign of S3 for output light same as that of incident light, for light with a large range of incident angle.

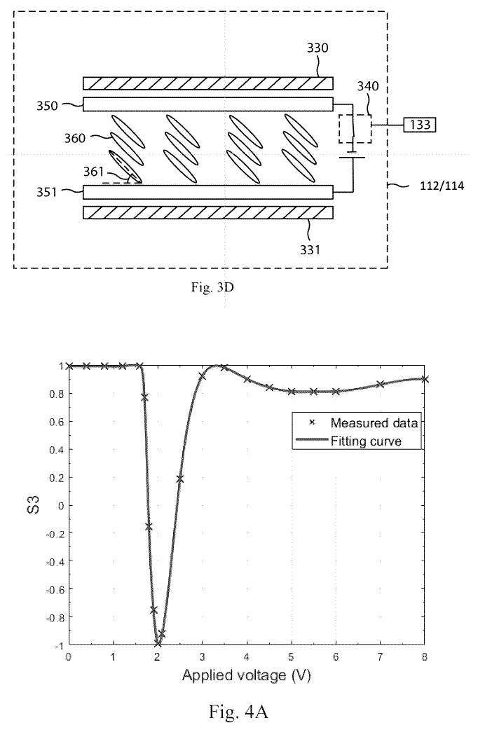

In one embodiment of the disclosure, the polarization converter 112/114 is made of a homogeneous LC cell. The cell gap is 2 micrometers. The LC material has birefringence of 0.284. The input light is right circularly polarized light with Stokes parameter S3=1, with 45 degrees of incident angle. When a voltage is applied, the measured Stokes parameter S3 of output light is shown in FIG. 4A. The Stokes parameter S3 of output light firstly decreases to −1 at 2V and then increases to 1. For the function of polarization conversion, a voltage of 2V can be used to convert the input right-handed circularly polarized (RCP) light to output left-handed circularly polarized (LCP) light. When no voltage is applied, the input RCP light maintains the polarization state after passing the sample. At applied voltage of 2V, the response time curves are shown in FIG. 4B. The rise and decay response times are 10 milliseconds and 33 milliseconds. The combined response time is 43 milliseconds. Further improvement of response time can be achieved by choosing a low-viscosity liquid crystal or optimizing cell structures.

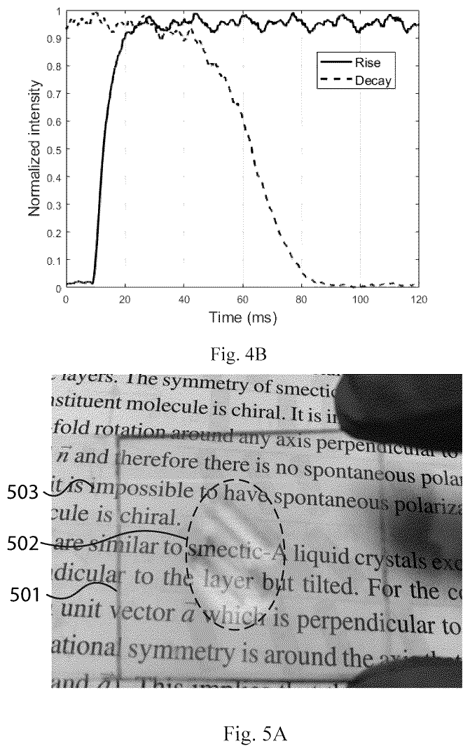

In one embodiment of the disclosure, two diffractive liquid crystal lenses with opposite responses to circularly polarized light are used. One has high efficiency for LCP light. The other has high efficiency for RCP light. The two lenses both work for oblique incident light with incident angle of 45 degrees. The focal points of two lenses have a spatial separation of 8 millimeters. The lenses are shown in FIG. 5A. The two lenses are combined together with a glue and form a lens set 501. Two images of ceiling light 502 are formed by the two lenses. The background text 503 are clearly visible, indicating a good see-through ability of lenses. As shown in FIG. 5B, the lens set 501 form two focal points 505A and 505B with an oblique incident light 504.

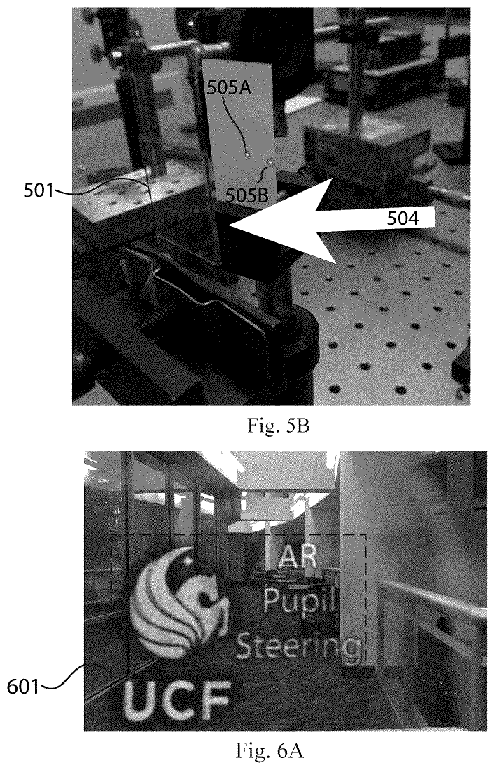

In one embodiment of the disclosure, the diffractive lens set 501 with two diffractive liquid crystal lenses whose polarization responses are opposite are used to form images with laser beam scanner. The polarization converter 112/114 is used to switch between two viewpoints. The image 601 viewed through the first viewpoint is shown in FIG. 6A. The image 602 viewed through the second viewpoint is shown in FIG. 6B.

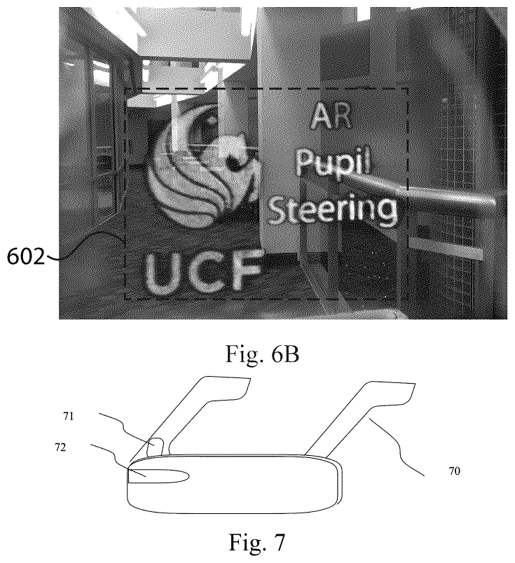

FIG. 7 shows an electronics apparatus according to an embodiment. The electronics apparatus 70 includes the optical display system as described above. The optical display system may include an optical image-generating display apparatus 71 and an exit pupil steering device 72 as described above. The electronics apparatus 70 may be an head-mounted display device, such as HMD glasses.

Although some specific embodiments of the disclosure have been demonstrated in detail with examples, it should be understood by a person skilled in the art that the above examples are only intended to be illustrative but not to limit the scope of the disclosure.

1. An exit pupil steering device, comprising:
at least one first lens coupler module, each of which includes:
a first controllable polarization converter, which is adapted to convert an incident light of a first polarization state into a second polarization state under control, and
a first diffractive lens, which diffracts the incident light of the first polarization state to a first pupil location of a viewer and passes the incident light of the second polarization state, or which passes the incident light of the first polarization state and diffracts the incident light of the second polarization state to the first pupil location; and
a second lens coupler module, which is placed behind the first lens coupler module and diffracts the incident light to a second pupil location of the viewer.

2. The exit pupil steering device according to claim 1, wherein the second lens coupler module includes:
a second controllable polarization converter, which converts the incident light of the first polarization state into the second polarization state, and
a second diffractive lens, which diffracts the incident light of the second polarization state; or
wherein the second lens coupler module includes:
a second controllable polarization converter, which converts the incident light of the second polarization state into the first polarization state, and
a second diffractive lens, which diffracts the incident light of the first polarization state.

3. The exit pupil steering device according to claim 1, wherein the second lens coupler module includes a second diffractive lens diffracts the incident light from a last first lens coupler module before the second lens coupler module.

4. The exit pupil steering device according to claim 3, wherein the second diffractive lens diffracts the incident light which has a polarization state opposite to that of the first diffractive lens of the last first lens coupler module.

5. The exit pupil steering device according to claim 4, wherein the first diffractive lens of the last first lens coupler module passes the incident light of the first polarization state or the second polarization state, and the second diffractive lens diffracts the incident light of the first polarization state or the second polarization state.

6. An optical display system, comprising:
an optical image-generating display apparatus, which generates display light; and
an exit pupil steering device according to claim 1, which receives the display light as the incident light and diffracts the incident light so that an exit pupil of the optical display system is steered to match a pupil location of a viewer.

7. The optical display system according to claim 6, further comprising:
a controlling unit, which controls the first controllable polarization converter of the first lens coupler module.

8. The optical display system according to claim 7, further comprising:
an eye tracking apparatus, which detects the location of a viewer's eye pupil and provides the location to the controlling unit,
wherein the controlling unit controls the first controllable polarization converter according to the location.

9. The optical display system according to according to claim 6, wherein the first controllable polarization converter has two possible states that can be selected by programming,
wherein in a first state, the first controllable polarization converter reverts the handedness of incident circularly polarized light; and
wherein in a second state, the first controllable polarization converter preserves the polarization state of incident circularly polarized light.

10. An electronics apparatus, including the optical display system according to claim 6.
